(19) United States
(12) Patent Application Publication
(10) Pub. No.: US 2025/0260024 A1
(43) Pub. Date: Aug. 14, 2025

(54) REDOX FLOW BATTERY INCLUDING STACKED FRAMES AND METHOD FOR MANUFACTURING THE SAME

(71) Applicant: Korea Institute of Energy Research, Daejeon (KR)

(72) Inventors: Chang-Soo JIN, Sejong-si (KR); Kyoung-Hee SHIN, Daejeon (KR); Sun-Hwa YEON, Sejong-si (KR); Myung-Seok JEON, Daejeon (KR); Se-Kook PARK, Daejeon (KR)

(73) Assignee: Korea Institute of Energy Research, Daejeon (KR)

(21) Appl. No.: 18/440,700

(22) Filed: Feb. 13, 2024

(51) Int. Cl. H01M 8/0258; H01M 8/0273; H01M 8/0286; H01M 8/1004; H01M 8/18

(52) U.S. Cl. CPC H01M 8/0258; H01M 8/0273; H01M 8/0286; H01M 8/1004; H01M 8/188

(57) ABSTRACT

According to one embodiment of the present disclosure, there may be provided a redox flow battery including: a plurality of unit cells, including a first electrode and a second electrode seated on flow frames, and a membrane provided between the first electrode and the second electrode; bipolar plates provided between the plurality of unit cells in order to connect electrical energy generated from the unit cell to adjacent unit cells; a pair of end plates respectively provided at both end portions of the plurality of unit cells in order to support a stack composed of the plurality of unit cells; and current collectors each provided at the inner side of the pair of end plates in order to move electrons generated in an electrochemical reaction, wherein the flow frames include a first cover plate and a second cover plate in which a plurality of through holes for flowing an electrolyte solution are formed, and a first flow path plate and a second flow path plate which are provided between the first cover plate and the second cover plate and have flow path portions of through patterns formed therein, the first cover plate, the second cover plate, the first flow path plate, and the second flow path plate are formed by stacking and assembling a plurality of films or thin plates on which a plurality of through patterns are formed in the same or different shapes and sizes at the same or different positions, and the through patterns are alternately overlapped to form a flow path.

### BACKGROUND

### 1. Field of Technology

This embodiment relates to a redox flow battery including stacked frames that can easily apply an optimal frame thickness and a method for manufacturing the same.

### 2. Related Technology

Redox flow batteries are a large-capacity power storage system, and are based on technology to chemically store and extract electrical energy. In particular, redox flow battery technology uses chemical reactions through electrolyte solutions for efficient storage and supply of energy, and is characterized by separate charging and discharging processes due to its flow-type characteristics. This allows redox flow batteries to operate stably and have a longer lifespan than other battery technologies. Therefore, redox flow batteries are used in various application fields such as renewable energy systems, grid standby power, and emergency power supply.

Such redox flow batteries mainly consist of an electrolyte, flow cells, a cathode and an anode, bipolar plates, and flow frames. In particular, frames used in redox flow batteries such as flow frames and bipolar plate frames securing bipolar plates may affect the performance and utilization of the redox flow batteries depending on the thickness.

Specifically, when the thickness of the frames used in a redox flow battery is thick, electrical conductivity may be improved by increasing the compression rate of the electrode, the capacity and energy density of the battery may be increased by accommodating a large amount of an electrolyte, and the efficiency of the battery may be improved by balancing the reaction rate of the cathode and the anode.

However, when the thickness of the frames used in the redox flow battery is thin, the weight and volume of the battery may be reduced to enable application even in limited spaces, facilitate installation and maintenance, and improve price competitiveness through cost reduction.

Accordingly, there is an increasing demand for technology that can easily adjust the frame thickness so as to optimize the thickness of the frames used in redox flow batteries according to the usage environment.

The discussions in this section are only to provide background information and do not constitute an admission of prior art.

### SUMMARY

Against this background, an object of this embodiment is to provide a redox flow battery including stacked frames, which can easily adjust the frame thickness while reducing the number of films or plates required when manufacturing a unit stacked frame using films or plates applied with an adhesive component.

Further, other object of this embodiment is to provide a method for manufacturing a redox flow battery including stacked frames, which enables mass production while reducing manufacturing time, production cost, and defect rate by manufacturing the frames using a stacking method.

Furthermore, another object of this embodiment is to provide a redox flow battery including stacked frames, which can optimize the frame thickness according to the usage environment, and a method for manufacturing the same.

In order to achieve the above-described object, one embodiment may provide a redox flow battery including: a plurality of unit cells, including a first electrode and a second electrode seated on flow frames, and a membrane provided between the first electrode and the second electrode; bipolar plates provided between the plurality of unit cells in order to connect electrical energy generated from the unit cell to adjacent unit cells; a pair of end plates respectively provided at both end portions of the plurality of unit cells in order to support a stack composed of the plurality of unit cells; and current collectors each provided at the inner side of the pair of end plates in order to move electrons generated in an electrochemical reaction, wherein the flow frames include a first cover plate and a second cover plate in which a plurality of through holes for flowing an electrolyte solution are formed, and a first flow path plate and a second flow path plate which are provided between the first cover plate and the second cover plate and have flow path portions of through patterns formed therein, the first cover plate, the second cover plate, the first flow path plate, and the second flow path plate are formed by stacking and assembling a plurality of films or thin plates on which a plurality of through patterns are formed in the same or different shapes and sizes at the same or different positions, and the through patterns are alternately overlapped to form a flow path.

At least one of the plurality of films or thin plates may include at least one of an opening in which the first electrode and the second electrode are seated, at least one through hole through which the electrolyte solution flows in and out, and flow path portions formed to be bent in one region of upper and lower sides of the opening.

The first cover plate, the second cover plate, the first flow path plate, and the second flow path plate may be joined by applying an adhesive component to one or both surfaces thereof.

The first flow path plate and the second flow path plate may include a plurality of pin-shaped irregularity portions formed in one region of the upper and lower sides of the opening.

The irregularity portion of the first flow path plate is formed in the direction from the flow path portions to the opening, and the irregularity portion of the second flow path plate is formed in the direction from the opening to the flow path portions, and thus they may be arranged to engage with each other in a misaligned manner.

The flow frames include a first flow frame on which the first electrode is seated and a second flow frame on which the second electrode is seated, and the thickness of the first flow frame and that of the second flow frame may be different from each other.

The redox flow battery further includes bipolar plate frames for fixing the bipolar plates, and the bipolar plate frames may be formed by stacking and assembling a plurality of films or thin plates on which a plurality of through patterns are formed in the same or different shapes and sizes at the same or different positions.

The thickness of the films or thin plates of the bipolar plate frames may be the same as or thinner than the thickness of the bipolar plates.

The bipolar plate frames may include a third cover plate and a fourth cover plate that are provided to be spaced apart from each other, and a first fixing plate and a second fixing plate that are provided between the third cover plate and the fourth cover plate, and the bipolar plate may be positioned between the first fixing plate and the second fixing plate.

Another embodiment may provide a method for manufacturing a redox flow battery, including: designing components of a plurality of films or thin plates having a plane perpendicular to the thickness direction of the part so that patterns of components required for a part including at least one of the flow frames and the bipolar plate frames are formed; manufacturing components according to the design; and stacking the manufactured components, wherein the components are manufactured using at least one of cutting using a mold, laser processing, press mold, injection processing, and water jet processing.

At least one of the components may include at least one of a flow path, an electrolyte solution entrance, and through patterns for electrode arrangement or bipolar plate arrangement.

In the stacking, the number of stacked components may be determined by considering at least one of differences in the compression rate of the electrode, the volume of the flow path, and the electrochemical reaction rate of the electrode.

The stacking may be performed by applying an adhesive component to one or both surfaces of the manufactured components and performing bonding.

In the stacking, the through structure or engraved structure required for the part may be formed by stacking and assembling a plurality of components on which through patterns are formed in the same or different shapes and sizes at the same or different positions.

Another embodiment may provide a redox flow battery including stacked frames manufactured by the method for manufacturing a redox flow battery.

As described above, according to one embodiment, it is possible to provide a redox flow battery including stacked frames, which can easily adjust the frame thickness while reducing the number of films or plates required when manufacturing a unit stacked frame using films or plates applied with an adhesive component.

In addition, according to another embodiment, it is possible to provide a method for manufacturing a redox flow battery including stacked frames, which enables mass production while reducing manufacturing time, production cost, and defect rate by manufacturing the frame using a stacking method.

Furthermore, according to another embodiment, it is possible to provide a redox flow battery which can easily implement a frame thickness to optimize electrode compression rate, electrolyte accommodation amount, electrode reaction rate difference, etc. according to the usage environment and a method of manufacturing the same.

The technical problems to be achieved in this document are not limited to the technical problems mentioned above, and other technical problems not mentioned can be clearly understood by those skilled in the art to which the present disclosure pertains from the description below.

### BRIEF DESCRIPTION OF THE DRAWINGS

In order that the disclosure may be well understood, there will now be described various forms thereof, given by way of example, reference being made to the accompanying drawings, in which:

FIG. 1 is an exploded view showing each configuration of a conventional redox flow battery;

FIG. 2 is an exploded view showing each configuration of a redox flow battery according to one embodiment;

FIG. 3 is a side exploded view showing the side of a flow frame according to one embodiment;

FIG. 4 is a front view of each configuration of the flow frame according to one embodiment;

FIG. 5 is a view showing a first cover plate according to one embodiment;

FIG. 6 is a view showing a first flow path plate according to one embodiment;

FIG. 7 is a view showing a second flow path plate according to one embodiment;

FIG. 8 is a side exploded view showing the side of a bipolar plate frame according to one embodiment; and

FIG. 9 is a flowchart showing a method for manufacturing a redox flow battery according to one embodiment.

### DETAILED DESCRIPTION OF EMBODIMENTS

Hereinafter, some embodiments will be described in detail through illustrative drawings. When adding reference numerals to components in each drawing, it should be noted that identical components are given the same reference numerals as much as possible even if they are shown in different drawings. Additionally, in describing the present disclosure, if it is determined that a detailed description of a related known configuration or function may obscure the gist of the present disclosure, the detailed description will be omitted.

In addition, when describing a component, terms such as first, second, A, B, (a), and (b) may be used. Such terms are only used to distinguish the component from other components, and the nature, sequence, order, or the like of the concerned component is not limited by the terms. When a component is described as being “linked,” “coupled,” or “connected” to other component, the component may be directly linked or connected to the other component, but it will be understood that another component may be “linked,” “coupled,” or “connected” between the respective components.

Redox flow batteries (RFB) are one of power storage technologies, and are a high-capacity battery system that chemically stores electrical energy and extracts it when needed. This technology has recently been spotlighted as an important tool for implementing large-scale energy storage systems with energy efficiency and long-term stability.

One of the main characteristics of redox flow batteries is that they are flow-type. In such redox flow batteries, the charging and discharging processes are physically separated, so energy may be exchanged efficiently using an electrolyte solution that chemically stores electrical energy. This is one of the important characteristics that allows redox flow batteries with flow-type characteristics to maintain stability even during operation and operate stably over a long period of time.

In addition, redox flow batteries store energy based on electrochemical reactions. The basic operating principle is realized by a chemical redox reaction between the cathode and the anode, and this reaction occurs through an electrolyte solution. When charging redox flow batteries, energy is supplied to the electrolyte to change chemicals into a reduction state, and when discharging, energy is extracted while returning the chemicals to an oxidation state. In such a process, the cathode and anode of the batteries are respectively oxidized and reduced, and the electrolyte transfers energy as it moves through the flow path between battery modules.

Furthermore, redox flow batteries can easily expand their capacity with a modular design, providing power storage solutions of various capacities. In addition, redox flow batteries can optimize the characteristics of the batteries by appropriately adjusting the electrolyte solution.

A redox flow battery may include configurations of an electrolyte, unit cells (flow cells), electrodes, bipolar plates, and flow frames.

The electrolyte is one of the most important components in a redox flow battery and serves to store chemical energy and transport electric charges. Due to the nature of the flow battery, the electrolyte may be used in a liquid form and may provide an electrical connection while flowing between the cathode and the anode. As active materials in such an electrolyte, representative redox pairs include iron/chromium-based (Fe/Cr), vanadium-based (VN), vanadium/bromine-based (V/Br), zinc/bromine-based (Zn/Br), and zinc/cerium-based (Zn/Ce), etc., but may not be limited thereto.

A cathode and an anode are located in unit cells (flow cells), and they are electrically connected through an electrolyte. The unit cells are responsible for the basic operation of the battery, and may easily expand the capacity of the battery system through the modular design.

Electrodes are places where a chemical reaction occurs, and chemicals may be oxidized and reduced to generate or consume electrical energy during the charging and discharging processes. Appropriate catalysts and materials are used at the cathode and anode of the electrodes, thereby promoting the reaction and providing an electrical connection.

The bipolar plates connect each unit cell and serve to collect current between the cathode and the anode. Through this, they provide electrical stability of the battery system and ensure electrical connection between the unit cells. The bipolar plates may be made of a material with high electrical conductivity, and typically a metal or carbon sheet may be used.

The flow frames serve to manage the flow of an electrolyte and form a zone where chemical reactions occur. Such flow frames may be designed to stably induce the electrolyte so that a chemical reaction is caused within the unit cells, and to allow the reaction to occur efficiently.

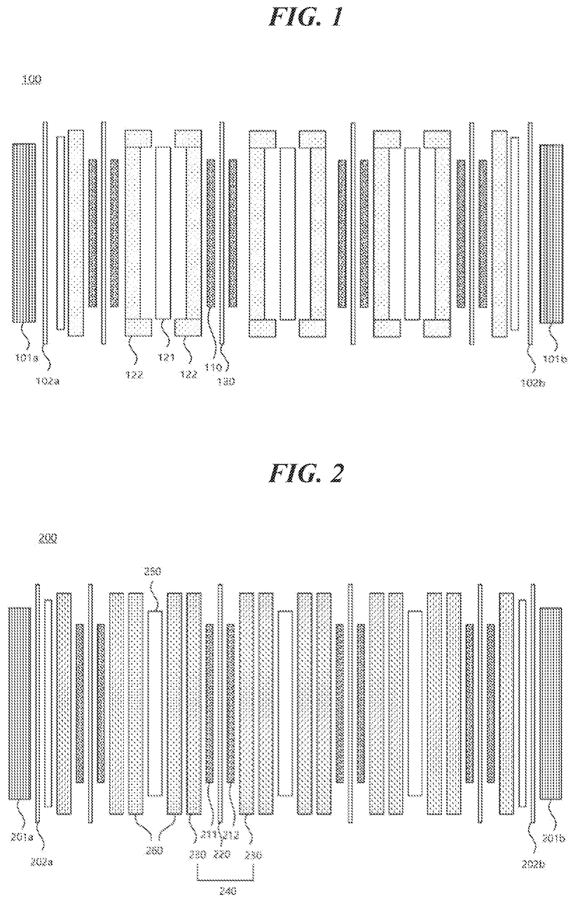

FIG. 1 is an exploded view showing each configuration of a conventional redox flow battery.

Referring to FIG. 1, a conventional redox flow battery 100 may be composed of a cell stack responsible for output and an electrolyte responsible for capacity, a pump for transferring an electrolyte solution, and peripherals. The cell stack is a device that causes oxidation-reduction reactions of active materials in the electrolyte solution during charging and discharging, and is an important part that determines the performance of the redox flow battery system.

As shown in FIG. 1, such a cell stack may be composed of current collectors 102a and 102b connected to external conducting wires, flow frames including a felt electrode 110 that causes a reaction and a manifold that serves as a flow of the electrolyte solution, bipolar plates 121 that electrically connect the respective unit cells in series or parallel and are in contact with the felt electrode 110, and a membrane 130 that is provided between the anode and the cathode and allows current to flow by the movement of ions.

Generally, the bipolar plates 121 are used by being fixed to the bipolar plate frames 122 rather than being used alone. At least one of the bipolar plate frames 122 and the flow frames includes an inlet and an outlet of the electrolyte solution and a manifold flow path, and should be sealed well to facilitate the flow of the electrolyte solution, prevent the internal electrolytes of the cathode and anode from being mixed, and prevent the electrolyte solution from flowing out to the outside. Since the thickness of such flow frames and bipolar plate frames is inversely proportional to the resistance characteristics of the cell stack while affecting the compression rate of the felt electrodes, technology for manufacturing the cell stack by optimizing the compression rate of the felt electrodes may be considered important.

Conventionally, parts such as flow frames and bipolar plate frames have been manufactured by injection methods, or thick polymer plates (mainly PVC, PP, PE, etc.) have been processed using engraving machines, numerical control work (NC), MCT, NCT, computer numerical control (CNC), or the like. The thickness of the flow frames is usually manufactured by engraving the flow path into a plate thicker than the depth of a flow path which is an electrolyte solution passage and using it, or by designing a mold to be engraved during injection. In order to adjust the thickness (adjust the compression rate) when the overall thickness of the plates is thicker than the desired thickness during processing and manufacturing, the entire plates may be cut to the desired thickness and used. When manufacturing flow frames or bipolar plate frames by using thick plates to process them with an engraving machine, NC, MCT, NCT, CNC, etc., thickness deviations and errors between the frames occur, the processing time takes a long time, which is disadvantageous for mass production, and high cost is a disadvantage. Flow frames or bipolar plate frames manufactured by injection methods have exhibited disadvantages such as bending and flexure of the frames, and in order to control the compression rate of felt electrodes, a process of remanufacturing an expensive injection mold and re-optimizing the injection process conditions is necessary, thereby requiring a lot of time and money.

Bending, flexure, and thickness deviation of the flow frames or bipolar plate frames manufactured in this way cannot provide a uniform flow of the electrolyte solution and adversely affect the reliability of the cell stack.

Flow frames or bipolar plate frames manufactured by existing methods need to solve problems such as bending, flexure, thickness deviation, etc. and high cost disadvantage, and the compression rate of felt electrodes may be easily controlled in order to improve the performance of the cell stack, and it is necessary to develop manufacturing technology for flow frames and bipolar plate frames that can be mass-produced.

The redox flow battery according to one embodiment of the present disclosure includes: a plurality of unit cells, including a first electrode and a second electrode seated on flow frames, and a membrane provided between the first electrode and the second electrode; bipolar plates provided between the plurality of unit cells in order to connect electrical energy generated from the unit cell to adjacent unit cells; a pair of end plates respectively provided at both end portions of the plurality of unit cells in order to support a stack composed of the plurality of unit cells; and current collectors each provided at the inner side of the pair of end plates in order to move electrons generated in an electrochemical reaction, wherein the flow frames may include a first cover plate and a second cover plate in which a plurality of through holes for flowing an electrolyte solution are formed, and a first flow path plate and a second flow path plate which are provided between the first cover plate and the second cover plate and have flow path portions of through patterns formed therein, the first cover plate, the second cover plate, the first flow path plate, and the second flow path plate may be formed by stacking and assembling a plurality of films or thin plates on which a plurality of through patterns are formed in the same or different shapes and sizes at the same or different positions, and the through patterns may be alternately overlapped to form a flow path.

FIG. 2 is an exploded view showing each configuration of a redox flow battery according to one embodiment.

Referring to FIG. 2, the redox flow battery 200 according to one embodiment of the present disclosure may include a plurality of unit cells 240, bipolar plates 250 provided between the plurality of unit cells 240, a pair of end plates 201a and 201b respectively provided at both end portions of the plurality of unit cells, and current collectors 202a and 202b each provided at the inner side of the pair of end plates 201a and 201b.

Specifically, the plurality of unit cells 240 may include a first electrode 211 and a second electrode 212 seated on flow frames 230, and a membrane 220 provided between the first electrode 211 and the second electrode 212. Here, the flow frames 230 may be formed by stacking and assembling a plurality of films or thin plates on which a plurality of through patterns are formed in the same or different shapes and sizes at the same or different positions, and may be a structure in which a flow path is formed by alternately overlapping the through patterns.

Carbon felts, carbon paper, carbon cloth, etc. having pores may be used as the first electrode 211 and the second electrode 212, and as the cathode or anode electrolyte solution flows between the pores, charging and discharging may occur by electrochemical reactions (redox reactions).

Carbon felts that may be used as the above-mentioned first electrode 211 and second electrode 212 may have various densities, pores, and thicknesses, and may be appropriately selected to be applicable depending on the purpose or characteristics of the applied redox flow battery. For example, when the porosity of the first electrode 211 or the second electrode 212 is too low or the thickness thereof is too thick, the number of stacks of at least one of the first cover plate 231, the second cover plate 232, the first flow path plate 233, and the second flow path plate 234 of the flow frames 230 may be increased so that the flow stability of the electrolyte solution is ensured by forming the compression ratio of the first electrode 211 or the second electrode 212 to have low compression ratio.

Meanwhile, when the electrochemical reaction rates are different in the first electrode 211 and the second electrode 212 depending on the active material and the thickness of the electrodes needs to be adjusted, the electrodes may be configured by varying the number of stacks of films or thin plates constituting the first electrode 211 side flow frame 230 and the second electrode 212 side flow frame 230.

The membrane 220 may be an ion exchange membrane generally applied to batteries. The membrane 220 may serve to selectively transmit ions, and ions may be exchanged for charge balance through the membrane 220, thereby enabling a redox reaction between the cathode and the anode.

Such a membrane 220 may include at least one selected from the group consisting of polyolefin (PO), polytetrafluoroethylene (PTFE), polyether ether ketone (PEEK), polysulfone (PSF), polyimide (PI), and polyamide-imide (PAI).

The bipolar plates 250 may be provided between the plurality of unit cells 240 to move the electrolyte solution and electrically connect the unit cells in series or parallel, and may be formed in various thicknesses.

Specifically, the design of the bipolar plates 250 can be appropriately changed within the range of 0.1 to 5.0 mm depending on the structure of the redox flow battery 200. The specific structure of the bipolar plates 250 will be described in more detail below with reference to the drawings.

The end plates 201a and 201b may be provided as a pair at the outermost portions, and electrolyte solution inlet and outlet, which are passages through which the electrolyte solution is injected and discharged, may be formed. The electrolyte solution inlet and outlet may be connected to a cathode electrolyte solution tank and an anode electrolyte solution tank, and the cathode electrolyte solution and the anode electrolyte solution may be circulated by driving a separately provided pump. Such end plates 201a and 201b may include at least one selected from the group consisting of polyethylene (PE), polypropylene (PP), polystyrene (PS), and polyvinyl chloride resin (PVC).

The current collectors 202a and 202b may include a conductive material, wherein the conductive material may include at least one selected from the group consisting of carbon, graphite, conductive sheets or films, and metals.

Typically, the cathode electrolyte solution and the anode electrolyte solution used in a redox flow battery may include an active material, a solvent, and an electrolyte, and the active material may dissociate in the solvent to cause an oxidation-reduction reaction, through which the redox flow battery may be charged and discharged.

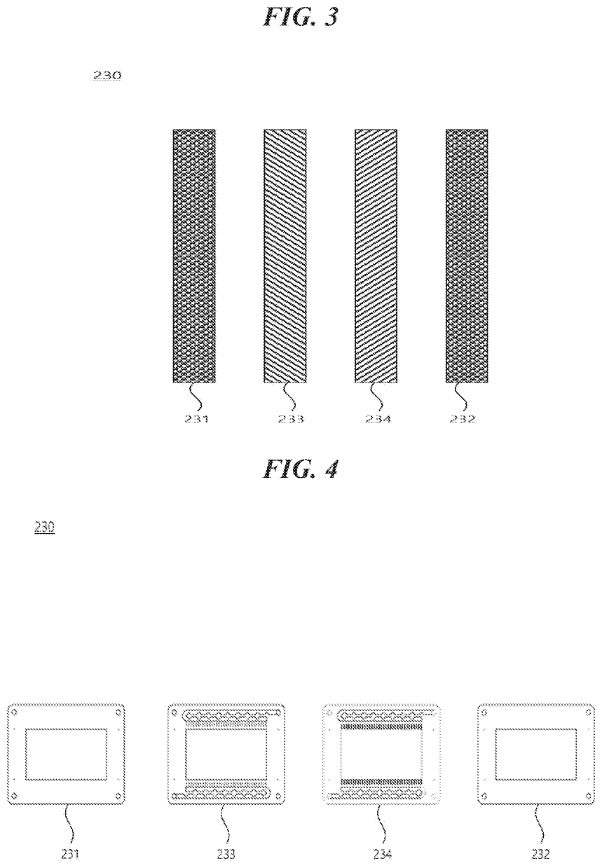

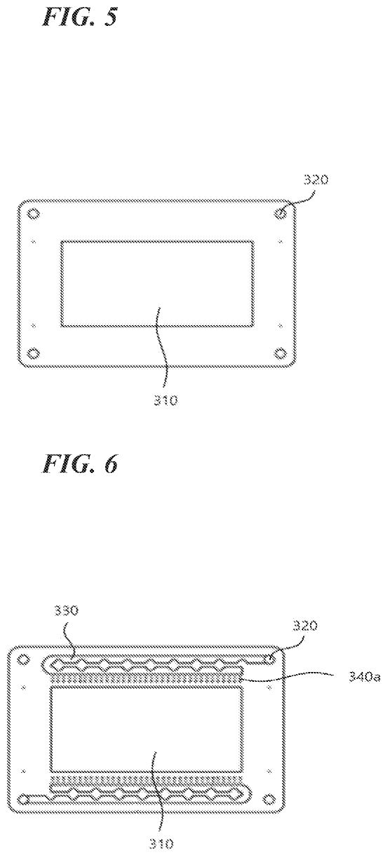

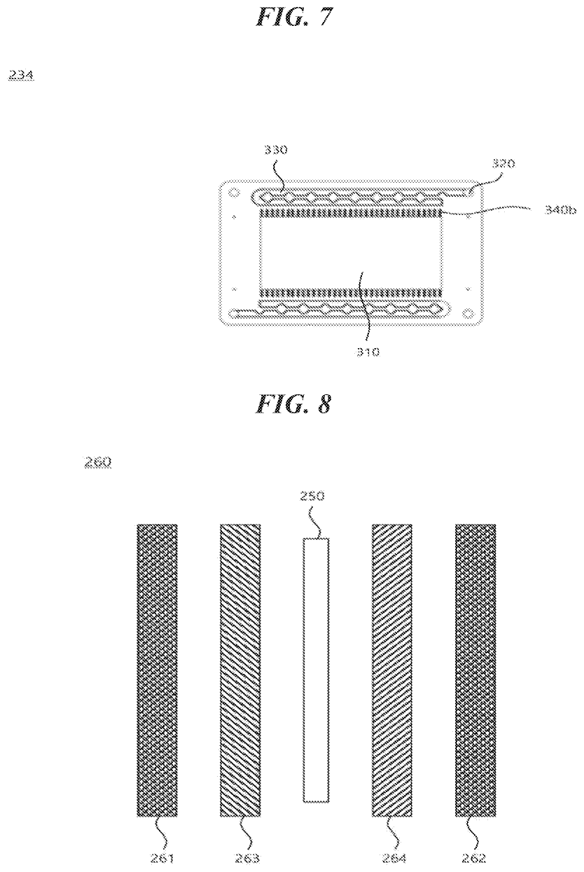

FIG. 3 is a side exploded view showing the side of a flow frame according to one embodiment, FIG. 4 is a front view of each configuration of the flow frame according to one embodiment, FIG. 5 is a view showing a first cover plate according to one embodiment, FIG. 6 is a view showing a first flow path plate according to one embodiment, and FIG. 7 is a view showing a second flow path plate according to one embodiment.

Referring to FIGS. 3 to 7, the flow frames 230 according to one embodiment may include a first cover plate 231 and a second cover plate 232 in which a plurality of through holes 320 for flowing an electrolyte solution are formed, and a first flow path plate 233 and a second flow path plate 234 which are provided between the first cover plate 231 and the second cover plate 232 and in which flow path portions 330 of through patterns are formed.

Specifically, the flow frames 230 may be formed by stacking the first cover plate 231, the second cover plate 232, the first flow path plate 233, and the second flow path plate 234 made of a plurality of films or thin plates. Here, at least one of the first cover plate 231, the second cover plate 232, the first flow path plate 233, and the second flow path plate 234 may include an opening 310 into which the first electrode 211 or the second electrode 212 is seated. In addition, at least one of the first cover plate 231, the second cover plate 232, the first flow path plate 233, and the second flow path plate 234 may include at least one of through holes 320 through which the electrolyte solution flows in and out.

Meanwhile, at least one of the first cover plate 231, the second cover plate 232, the first flow path plate 233, and the second flow path plate 234 included in the flow frames 230 may include flow path portions 330 formed to be bent in one region of at least one of the upper and lower sides of the opening 310. Here, the volume of the flow path portions 330 may be adjusted depending on the stacked sheet number or thickness of films or thin plates in which the flow path portions 330 are formed.

Furthermore, the flow frames 230 may include a first flow frame on which the first electrode 211 is seated and a second flow frame on which the second electrode 212 is seated. Here, when the thicknesses of the first electrode 211 and the second electrode 212 are different due to the electrochemical reaction rate by the active material, the thicknesses of the first flow frame and the second electrode may be adjusted by adjusting the stacked sheet number or thickness of the films or thin plates, thereby designing the first flow frame and the second flow frame to have different thicknesses.

For example, when zinc (Zn) and bromine (Br) are used as the first electrode 211 and the second electrode 212, since there is a possibility of causing an electrical short circuit by forming metal in the first electrode 211 to penetrate the membrane 220, the thickness of the first flow frame may be designed to be thicker than the thickness of the second flow frame. Adjusting the thickness of the flow frames 230 may be performed by adjusting the stacked sheet number or thickness of the films or thin plates constituting the flow frame 230.

The flow frames 230 may include at least one selected from the group consisting of polyethylene (PE), polypropylene (PP), polystyrene (PS), polycarbonate (PC), polyacetal (POM), polymethyl methacrylate (PMMA), polyurethane (PUR), polyethylene terephthalate (PET), polyamide-imide (PAI), polyetherimide (PEI), polyimide (PI), polyphenylene sulfide (PPS), polyether ether ketone (PEEK), polyvinyl chloride resin (PVC), phenolic formaldehyde resin (PF), polytetrafluoroethylene (PTFE), polybutylene terephthalate (PBT), polyphenylene oxide (PPO), polyphenylene ether (PPE), and combinations thereof, may include commercially available products such as polybenzimidazole (PBI), electromagnetic wave shielding resins, MC-nylon, etc. purchased and used, or may also include plates of metal materials such as aluminum and iron.

It is desirable to appropriately adjust and apply such materials of the flow frames 230 depending on the type of active materials or electrolyte solutions used in the redox flow battery. For example, when the electrolyte solution is a strong acid or base, polymer-based materials with high chemical resistance may be used, when a redox couple rather than a strong acid or base is used, materials of metals may also be used, and in the case of a vanadium redox flow battery, general-purpose plastics or high-performance plastics may be used.

The flow frames 230 may include a first cover plate 231 and a second cover plate 232 that are spaced apart from each other, and a first flow path plate 233 and a second flow path plate 234 that are provided between the first cover plate 231 and the second cover plate 232.

The first cover plate 231 and the second cover plate 232 may serve to prevent flow path portions 330 of the first flow path plate 233 and the second flow path plate 234 from being damaged by the bipolar plates 250. Here, the thicknesses of the first flow path plate 233 and the second flow path plate 234 may be formed to be thicker than the thicknesses of the first cover plate 231 and the second cover plate 232.

In addition, the number of stacked sheets of the first flow path plate 233 and the second flow path plate 234 may vary depending on the thicknesses of the first electrode 211 and the second electrode 212. For example, when the thicknesses of the first electrode 211 and the second electrode 212 increase, the number of stacked sheets of the first flow path plate 233 and the second flow path plate 234 may increase proportionally.

Meanwhile, the first cover plate 231, the second cover plate 232, the first flow path plate 233, and the second flow path plate 234 may be joined together with each other by being applied with an adhesive component on one or both surfaces thereof to prevent leakage of the electrolyte solution.

Specifically, the first cover plate 231 and the second cover plate 232 and the first flow path plate 233 and the second flow path plate 234 included in the flow frames 230 are bonded to each other through an adhesive component, thereby facilitating manufacturing and reducing raw material costs by reducing the number of films or plates required when manufacturing unit stacked frames while preventing leakage of the electrolyte solution.

Conventionally, the first cover plate 231 and the second cover plate 232 and the first flow path plate 233 and the second flow path plate 234 have been manufactured by providing with a gasket portion and a bonding film therebetween. Therefore, a gasket portion and a bonding film have had to be used between the first cover plate 231 and the first flow path plate 233, between the first flow path plate 233 and the second flow path plate 234, and between the second flow path plate 234 and the second cover plate 232, and accordingly, the number of films or plates required when manufacturing unit stacked frames has been increased.

However, according to one embodiment of the present disclosure, the number of films or plates required may be greatly reduced by applying an adhesive component between the first cover plate 231 and the second cover plate 232 and the first flow path plate 233 and the second flow path plate 234 without using the gasket portion and the bonding film.

The first cover plate 231 and the second cover plate 232 may include at least one through hole 320 so that the electrolyte solution flows in and out. Such through holes 320 may be formed in corner regions of the first cover plate 231 and the second cover plate 232, respectively.

The first flow path plate 233 and the second flow path plate 234 may include flow path portions 330 formed to be bent in at least one region of the upper and lower sides of the opening 310, and the flow path portions 330 provided in at least one region of the upper and lower sides of the opening 310 may be horizontally provided while being bent in different directions.

The volume, shape, and cross-sectional area of such flow path portions 330 may be adjusted by the number of stacked sheets of the first flow path plate 233 and the second flow path plate 234. Furthermore, patterns in which the opening 310 is formed in a shape corresponding to the current collectors may also be possible.

Meanwhile, the first cover plate 231, the second cover plate 232, the first flow path plate 233, and the second flow path plate 234 may be formed by stacking and assembling a plurality of films or thin plates on which a plurality of through patterns are formed in the same or different shapes and sizes at the same or different positions. Here, the through patterns formed in the films or thin plates may be alternately overlapped to form a flow path.

The first flow path plate 233 and the second flow path plate 234 may include a plurality of pin-shaped irregularity portions 340a and 340b formed in one region of upper and lower sides of the opening 310. The irregularity portions 340a and 340b formed on the first flow path plate 233 and the second flow path plate 234 may increase the adhesion area between the first cover plate 231 and the first flow path plate 233, between the first flow path plate 233 and the second flow path plate 234 and between the second flow path plate 234 and the second cover plate 232 to improve adhesion, thereby preventing leakage of the electrolyte solution.

The irregularity portion 340a of the first flow path plate 233 may be formed in the shape of a plurality of fins in the direction from the flow path portions 330 to the opening 310, and the irregularity portion 340b of the second flow path plate 234 may be formed in the shape of a plurality of fins in the direction from the opening 310 to the flow path portions 330. The irregularity portion 340a of the first flow path plate 233 and the irregularity portion 340b of the second flow path plate 234 formed in this way may be provided to engage with each other in a misaligned manner.

FIG. 8 is a side exploded view showing the side of a bipolar plate frame according to one embodiment.

Referring to FIG. 8, the redox flow battery 200 according to the present disclosure may further include bipolar plate frames 260 capable of fixing the bipolar plates 250.

Specifically, the bipolar plate frames 260 may be formed by stacking and assembling a plurality of films or thin plates on which a plurality of through patterns are formed in the same or different shapes and sizes at the same or different positions.

The thickness of the films or thin plates of the bipolar plate frames 260 may be the same as or thinner than the thickness of the bipolar plates 250. Meanwhile, when the thickness of the bipolar plates 250 increases, the thickness of the bipolar plate frames 260 may also increase proportionally so as to prevent water leakage and liquid leakage, and the number of the sheets of the films or thin plates stacked may also increase.

The bipolar plate frames 260 may include a third cover plate 261 and a fourth cover plate 262 that are provided to be spaced apart from each other, and a first fixing plate 263 and a second fixing plate 264 which are provided between the third cover plate 261 and the fourth cover plate 262. In addition, the bipolar plates 250 may be fixed more tightly by being positioned between the first fixing plate 263 and the second fixing plate 264.

Meanwhile, the bipolar plate frames 260 like the flow frames 230 may greatly reduce the number of films or plates required by applying an adhesive component between the third cover plate 261 and the fourth cover plate 262, and the first fixing plate 263 and the second fixing plate 264, without using a gasket portion and a bonding film.

In the above description, although the case in which the flow frames 230 and the bipolar plate frames 260, which are manufactured by stacking components in the form of films or thin plates among the parts of the redox flow battery 200, are adopted, has been exemplarily described, it goes without saying that a redox flow battery may be constructed by adopting also other parts such as current collectors, end plates manufactured in the same way.

The redox flow battery of the present disclosure configured as described above may improve reliability and performance, reduce the number of films or plates required when manufacturing unit stacked frames, and easily adjust the frame thickness at the same time by applying parts manufactured by a method of stacking a plurality of films or thin plates to reduce the occurrence of deviations due to processing errors.

Next, a method for manufacturing a redox flow battery according to another embodiment of the present disclosure will be described in detail.

There may be provided a method for manufacturing a redox flow battery according to one embodiment of the present disclosure, the method including: designing components of a plurality of films or thin plates having a plane perpendicular to the thickness direction of the parts so that patterns of components required for parts including at least one of the flow frames and the bipolar plate frames are formed; manufacturing the components according to the design; and stacking the manufactured components, wherein the components are manufactured using at least one of cutting using a mold, laser processing, press mold, injection processing, and water jet processing.

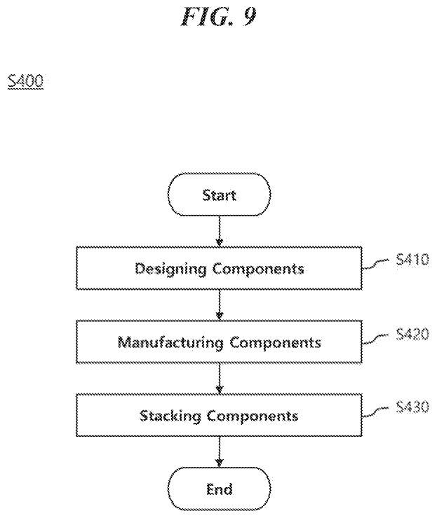

FIG. 9 is a flowchart showing a method for manufacturing a redox flow battery according to one embodiment.

Referring to FIG. 9, a method S400 for manufacturing a redox flow battery according to one embodiment of the present disclosure may include designing components S410, manufacturing the components S420, and stacking the manufactured components S430.

At least one ofthe components may include at least one of a flow path, an electrolyte solution entrance, and through patterns for electrode arrangement or bipolar plate arrangement.

In designing components S410, when the parts are divided into a combination of a plurality of film or thin plate shapes having a plane perpendicular to the thickness direction of parts are formed so that patterns of components required for parts including at least one of the flow frames 230 and the bipolar plate frames 260 are formed, a process designed so that the patterns of the components required for the parts are formed on each of the films or thin plates may be performed.

Specifically, the components of the flow frames 230 and the bipolar plate frames 260 may be designed so that patterns of the components required for the flow frames 230 and the bipolar plate frames 260 are formed on each film or thin plate when the flow frames are divided into a combination of sheet shapes a plurality of film or thin plates having a plane perpendicular to the thickness direction of the flow frames. At least one of such flow frames 230 and bipolar plate frames 260 may design components having various structures such as a flow path-formed shape, a shape corresponding to the current collectors, and through holes. In detail, the components may design components of a shape corresponding to cover plates including at least one through hole through which the electrolyte solution flows in and out, and flow path plates on which through-type patterns for forming a flow path portion are provided. However, the components of the flow frames 230 and the bipolar plate frames 260 are not limited to the cover plates and flow path plates only.

Next, components can be manufactured according to the design S420.

The components may be manufactured using at least one of cutting using a mold, laser processing, press mold, injection processing, and water jet processing according to the design of films or thin plates. Preferably, the component may be manufactured using water jet processing according to the design of films or thin plates.

For example, the design value of the water jet equipment program is changed so that the cover plates and flow path plates, which are components, correspond to each of the pre-designed shapes, the water jet equipment is positioned on a material having a form of films or thin plates so that it corresponds to components, that is, cover plates and flow path plates, respectively, and then components in the form of various shapes of films or thin plates may be manufactured by cutting the material having the form of films or thin plates.

Water jet processing is easy even if the thickness of the films or thin plates increases, causes less damage when processing multiple plates, and may facilitate manufacturing since only the design value of the equipment program needs to be changed even if the part size changes. In addition, since water jet processing uses only water and abrasives, so it is environmentally friendly and can process a variety of frame materials such as metal, plastic, glass, and ceramic, there may be fewer restrictions on materials. In addition, since water jet processing is capable of processing complex and diverse shapes such as curves, has almost no thermal deformation residual stress, and does not require post-treatment, the process may be simplified.

Meanwhile, complex and diverse shapes may be easily manufactured with a low error range through water jet processing.

The manufacture of components S420 according to the design may be repeatedly performed multiple times for the same design depending on the thickness and specifications of the flow frames 230 and the bipolar plate frames 260 required for the applied redox flow battery.

The thickness of at least one of the flow frames 230 and the bipolar plate frames 260 may be determined by considering at least one of the compression rate of the electrode, the volume (depth and area) of the flow path, and the difference in electrochemical reaction rates between the cathode and the anode. Such a plurality of films or thin plates may be the same material or different materials, and the material may include at least one selected from the group consisting of polyethylene (PE), polypropylene (PP), polystyrene (PS), polycarbonate (PC), polyacetal (POM), polymethyl methacrylate (PMMA), polyurethane (PUR), polyethylene terephthalate (PET), polyamide-imide (PAI), polyetherimide (PEI), polyimide (PI), polyphenylene sulfide (PPS), polyether ether ketone (PEEK), polyvinyl chloride resin (PVC), phenolic formaldehyde resin (PF), polytetrafluoroethylene (PTFE), polybutylene terephthalate (PBT), polyphenylene oxide (PPO), polyphenylene ether (PPE), and combinations thereof, may include commercially available products such as polybenzimidazole (PBI), electromagnetic wave shielding resins, MC-nylon, etc. purchased and used, or may also include plates of metal materials such as aluminum and iron.

Specific materials may be appropriately selected and applied depending on the active materials used in the redox flow battery. In addition, respective components in which a flow path, electrolyte solution inlet and outlet, and through patterns for electrode arrangement are formed on films or thin plates may be manufactured through the process of manufacturing the components according to the above design.

Finally, the manufactured components may be stacked S430.

The flow frames 230 and the bipolar plate frames 260 could be manufactured by stacking multiple sheets of the respective components in the form of films or thin plates by considering it after selecting the compression rate of the electrode and the volume (depth and volume) of the flow path. For example, as the thickness of the electrode increases, the number of stacks may also increase proportionally.

The flow frames 230 and the bipolar plate frames 260 may be formed by stacking and assembling a plurality of sheets of films or thin plates on which various through patterns are formed to achieve desired specifications of electrode compression rate, and flow path depth and area. That is, when stacking the manufactured components, the through structure or engraved structure required for the flow frames is formed by stacking and assembling a plurality of films or thin plates on which through patterns are formed in the same or different shapes and sizes at the same or different positions.

For example, the flow frames 230 and the bipolar plate frames 260 may be formed by stacking a plurality of cover plates and flow path plates. Specifically, the flow frames 230 may be manufactured by sequentially stacking the cover plate, the flow path plate, and the cover plate. At this time, it is desirable to apply the flow path plate by adjusting the number of stacked sheets depending on the compression ratio of the electrode, and the flow path depth and area can be adjusted depending on the number of stacked sheets of the flow path plates. The respective plurality of cover plates and flow path plates may be the same material or different materials.

The flow frames 230 and the bipolar plate frames 260 may be formed by stacking a plurality of cover plates and fixing plates. Specifically, the bipolar plate flow frames 260 may be manufactured by sequentially stacking the cover plate, the fixing plate, and the cover plate. Here, a separate flow path may not be formed in the fixing plates. That is, the flow path, which is a passage through which the electrolyte solution moves, may be formed only in the flow frames 230 and may not be formed in the bipolar plate frames 260. Meanwhile, the respective plurality of cover plates and flow path plates may be the same material or different materials.

A plurality of cover plates, flow path plates, and fixing plates do not use a gasket portion and a bonding film, but an adhesive component is applied between a plurality of cover plates and flow path plates or between a plurality of cover plates and fixing plates so that the number of films or plates required can be greatly reduced, and the process can be automated to implement mass production.

Meanwhile, the adhesive component may be applied to a plurality of cover plates and flow path plates according to a desired pattern. At this time, a roller method, a spray method, a screen printing method, or a dispenser application method may be used as a method of applying the adhesive component.

When the components manufactured as described above are completed to be stacked in S430, at least one of the flow frames 230 and the bipolar plate frames 260 may be manufactured.

As described above, according to the method S400 for manufacturing a redox flow battery according to one embodiment of the present disclosure, a plurality of components are manufactured in the form of films or thin plates and they are stacked and assembled according to the desired specifications so that manufacturing time, production costs and defect rates can be reduced, and the thickness deviation is small, so it can be easily applied to automated processes to enable mass production. In addition, since it is easy to change the design depending on the compression ratio of the electrode, etc. by manufacturing the flow frames 230 or the bipolar plate frames 260 by a method of stacking a plurality of films or thin plates, manufacturing time and cost can be reduced.

In the above description, the method for manufacturing flow frames and bipolar plate frames among the parts of the redox flow battery has been described in detail, but it will be clearly understood that other parts such as the current collectors and end plates can also be manufactured in such a manner that a plurality of components are manufactured in the form of films or thin plates and stacked and assembled.

Since terms such as “include,” “compose,” or “have” described in the above description mean that the corresponding component may be included unless specifically stated to the contrary, it should be interpreted that other components are not excluded, but they may be further included. All terms including technical or scientific terms, unless otherwise defined, have the same meaning as generally understood by a person of ordinary skill in the art to which the present disclosure pertains. Commonly used terms, such as terms defined in a dictionary, should be interpreted as consistent with the contextual meaning of the related technology, and should not be interpreted in an idealized or overly formal sense unless explicitly defined in the present disclosure.

The above description is merely an illustrative explanation of the technical idea of the present disclosure, and various modifications and variations will be possible to those skilled in the art to which the present disclosure pertains without departing from the essential characteristics of the present disclosure. Accordingly, the embodiments disclosed in the present disclosure are not intended to limit the technical idea of the present disclosure, but are for illustrative purposes, and the scope of the technical idea of the present disclosure is not limited by such embodiments. The scope of protection of the present disclosure should be interpreted in accordance with the claims below, and all technical ideas within the scope equivalent thereto should be construed as being included in the scope of rights of the present disclosure.

1. A redox flow battery comprising:
a plurality of unit cells, including a first electrode and a second electrode seated on flow frames, and a membrane provided between the first electrode and the second electrode; bipolar plates provided between the plurality of unit cells in order to connect electrical energy generated from the unit cell to adjacent unit cells;
a pair of end plates respectively provided at both end portions of the plurality of unit cells in order to support a stack composed of the plurality of unit cells; and
current collectors each provided at the inner side of the pair of end plates in order to move electrons generated in an electrochemical reaction,
wherein the flow frames include a first cover plate and a second cover plate in which a plurality of through holes for flowing an electrolyte solution are formed, and a first flow path plate and a second flow path plate which are provided between the first cover plate and the second cover plate and have flow path portions of through patterns formed therein, the first cover plate, the second cover plate, the first flow path plate, and the second flow path plate are formed by stacking and assembling a plurality of films or thin plates on which a plurality of through patterns are formed in the same or different shapes and sizes at the same or different positions, and the through patterns are alternately overlapped to form a flow path.

2. The redox flow battery of claim 1, wherein at least one of the plurality of films or thin plates includes at least one of an opening in which the first electrode and the second electrode are seated, at least one through hole through which the electrolyte solution flows in and out, and flow path portions formed to be bent in one region of upper and lower sides of the opening.

3. The redox flow battery of claim 1, wherein the first cover plate, the second cover plate, the first flow path plate, and the second flow path plate is joined by applying an adhesive component to one or both surfaces thereof.

4. The redox flow battery of claim 2, wherein the first flow path plate and the second flow path plate include a plurality of pin-shaped irregularity portions formed in one region of the upper and lower sides of the opening.

5. The redox flow battery of claim 4, wherein the irregularity portion of the first flow path plate is formed in the direction from the flow path portions to the opening, and the irregularity portion of the second flow path plate is formed in the direction from the opening to the flow path portions, and thus they are arranged to engage with each other in a misaligned manner.

6. The redox flow battery of claim 1, wherein the flow frames include a first flow frame on which the first electrode is seated and a second flow frame on which the second electrode is seated, and the thickness of the first flow frame and that of the second flow frame are different from each other.

7. The redox flow battery of claim 1, further comprising bipolar plate frames for fixing the bipolar plates,
wherein the bipolar plate frames are formed by stacking and assembling a plurality of films or thin plates on which a plurality of through patterns are formed in the same or different shapes and sizes at the same or different positions.

8. The redox flow battery of claim 7, wherein the thickness of the films or thin plates of the bipolar plate frames is the same as or thinner than the thickness of the bipolar plates.

9. The redox flow battery of claim 7, wherein the bipolar plate frames include a third cover plate and a fourth cover plate that are provided to be spaced apart from each other, and a first fixing plate and a second fixing plate that are provided between the third cover plate and the fourth cover plate, and the bipolar plate is positioned between the first fixing plate and the second fixing plate.

10. A method for manufacturing a redox flow battery, comprising:
designing components of a plurality of films or thin plates having a plane perpendicular to the thickness direction of the part so that patterns of components required for a part including at least one of the flow frames and the bipolar plate frames are formed;
manufacturing components according to the design; and
stacking the manufactured components,
wherein the components are manufactured using at least one of cutting using a mold, laser processing, press mold, injection processing, and water jet processing.

11. The method of claim 10, wherein at least one of the components includes at least one of a flow path, an electrolyte solution entrance, and through patterns for electrode arrangement or bipolar plate arrangement.

12. The method of claim 10, wherein in the stacking, the number of stacked components is determined by considering at least one of differences in the compression rate of the electrode, the volume of the flow path, and the electrochemical reaction rate of the electrode.

13. The method of claim 10, wherein the stacking is performed by applying an adhesive component to one or both surfaces of the manufactured components and performing bonding.

14. The method of claim 10, wherein in the stacking, the through structure or engraved structure required for the part is formed by stacking and assembling a plurality of components on which through patterns are formed in the same or different shapes and sizes at the same or different positions.

15. A redox flow battery comprising stacked frames manufactured by the manufacturing method of claim 10.
